(19) United States
(12) Patent Application Publication
(10) Pub. No.: US 2013/0133829 A1
(43) Pub. Date: May 30, 2013

(54) INTERNAL ELECTROFUSION RING COUPLER

(71) Applicant: Robert Pinder, Quebec (CA)

(72) Inventor: Robert Pinder, Quebec (CA)

(21) Appl. No.: 13/814,752

(22) PCT Filed: Aug. 11, 2011
(86) PCT No.: PCT/CA2011/000906

§ 371 Date: Feb. 7, 2013

Related U.S. Application Data
(60) Provisional application No. 61/372,777, filed on Aug. 11, 2010.

(51) Int. Cl. B29C 65/34

(52) U.S. Cl. CPC B29C 65/34
USPC 156/296; 285/21.2

(57) ABSTRACT

An internal ring coupler for fusing and sealing abutted ends of two pipes is provided. The ring coupler formed by a plastic ring having a substantially flat outer surface with at least two bands of thermoplastic welding rod encircling the outer surface of the plastic ring is provided. The coupling is placed on the inner circumference of two abutted plastic pipe ends. An electrical current is applied to the bands fusing the ring coupler to the interior of the ends of the two pipes to fuse the welding rod between the pipes and the coupler forming a seal over the pipe join.

### CROSS-REFERENCE TO RELATED APPLICATIONS

This application claims priority from U.S. Provisional Patent application No. 61/372,777 filed on Aug. 11, 2010, the contents of which is hereby incorporated by reference in its entirety.

### TECHNICAL FIELD

The present disclosure relates generally to thermoplastic welding and, in particular, to coupling plastic pipes using thermoplastic welding.

### BACKGROUND

Thermoplastic welding technology enables thermoplastic components to be electrofused, or welded, together. Some notable improvements in this field of technology are disclosed in U.S. Pat. No. 5,407,520 (Butts et al.) entitled “Welding rod” and in U.S. Pat. No. 5,407,514 (Butts et al.) entitled “Method for welding thermoplastic materials”. These patents disclose an improved welding rod having a solid homogeneous core of thermoplastic material and a resistance element comprised of a plurality of wires. The welding rod is positioned between members of the thermoplastic material to be welded and a current and pressure is applied to the resistance element causing the thermoplastic material of the solid core and the adjacent thermoplastic members to fuse and form a unitary weld. Simultaneously the electrical resistance element is embedded in the weld, mechanically reinforcing and strengthening the connection. These patents also disclose a method for electric fusion welding of thermoplastic members wherein the welding rod is pre-attached to one of the thermoplastic members.

One problem that has arisen in the coupling of plastic pipes is consistency of the join made between the pipes. Pipes may be coupled by welding of the ends of the pipes together, couplers positioned between the pipe ends, or by utilizing mechanical couplers positioned either internally or externally relying on a friction or pressure fit. Existing solutions are either time consuming, difficult to implement due to location and structure of the weld, or are prone to leaking due to the physical configuration of the coupling between the pipes. Solutions that require external coupling of the pipes are difficult to use in large diameter applications and coupling solutions that are positioned between pipe end interfaces can be difficult to align if the pipe ends are uneven or do not provide a smooth surface to ensure a consistent seal. In addition existing solutions that utilize gasket joints in a coupler between pipe ends do not provide the longevity of a fusion joint.

Accordingly, ensuring a consistent leak proof seal between plastic pipes is very difficult to achieve. This has remained a technical problem for which an adequate solution has, until now, yet to be devised.

### SUMMARY

In accordance with the present disclosure there is provided a ring coupler for fusing and sealing a first pipe end to a second pipe end, the ring coupler comprising a plastic ring having a substantially flat outer surface; a first thermoplastic welding rod band encircling the outer surface of the plastic ring, the first band proximate to one outer edge of the ring; a second thermoplastic welding rod band encircling the outer surface of the plastic ring, the second band proximate to an opposite outer edge from the first band of the ring; wherein the coupler is placed inside the abutted first and second pipe ends to cover the inner circumference of a pipe join, and the first and second welding rod bands fuse the ring coupler to the interior of the two abutted pipes by application of an electrical current to heat the welding rod.

In accordance with another aspect of the present disclosure there is also provided a method of coupling pipes, the method comprising providing an internal ring coupler comprising a plastic ring having a substantially flat outer surface; a first thermoplastic welding rod band encircling the outer surface of the plastic ring, the first band proximate to one outer edge of the ring; a second thermoplastic welding rod band encircling the outer surface of the plastic ring, the second band proximate to an opposite outer edge from the first band of the ring; positioning the ring coupler internally within the ends of two abutted pipe ends along an inner circumference to cover a join of the abutted pipe ends; and applying current to the first and second welding rod bands to the ends of the welding wire to weld the ring coupler to the interior surfaces of the pipe ends.

In accordance with yet another aspect of the present disclosure there is also provided a method of manufacturing an internal electrofusion ring coupler, the method comprising forming a plastic ring having a substantially flat outer surface; positioning a first thermoplastic welding rod band on the outer surface of the plastic ring relative to a first outer edge of the plastic ring; positioning a second thermoplastic welding rod band on the outer surface of the plastic ring relative to a second outer edge of the plastic ring, parallel to the first band; wherein the first and second thermoplastic welding rod bands are fused to the plastic ring by applying pressure and a current source to the thermoplastic band enabling the first and second band to fuse.

### BRIEF DESCRIPTION OF THE DRAWINGS

Further features and advantages of the present disclosure will become apparent from the following detailed description, taken in combination with the appended drawings, in which:

FIG. 1 is an internal electrofusion ring coupler;

FIG. 2 is an internal electrofusion ring coupler having separate welding rod bands;

FIG. 3 is an internal electrofusion ring coupler having separate welding rod bands with a pressure test cavity within each band;

FIG. 4 is an internal electrofusion ring coupler where one side of the coupler is compressible;

FIG. 5 is a side view illustrating an internal electrofusion ring coupler positioned between two pipe ends;

FIG. 6 is a method of installing an internal electrofusion ring coupler; and

FIG. 7 is a method of manufacturing an internal electrofusion ring coupler.

It will be noted that throughout the appended drawings, like features are identified by like reference numerals.

### DETAILED DESCRIPTION

In general, and by way of overview, the present disclosure is directed to an internal electrofusion ring coupler and a method of using this internal electrofusion ring coupler. A method of manufacturing this novel internal electrofusion ring coupler is also disclosed herein.

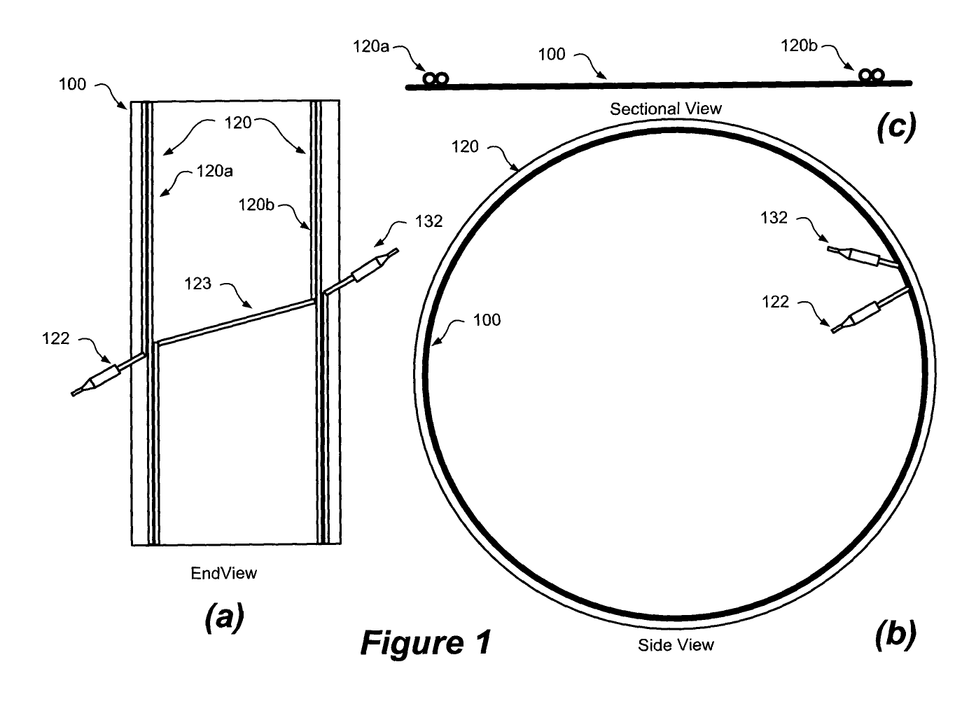

As depicted by way of example in FIG. 1 (a) to (c), a single band internal electrofusion ring coupler is provided, also simply referred to as the “coupler”. The coupler comprises a circular plastic ring 100 having a substantially flat exterior surface, as shown in FIG. 1 (b) formed of a plastic suitable to bonding with a thermoplastic resin. The ring may be formed by fusing the ends together of a generally rectangular piece of plastic to form the ring. Alternatively, the ring may be formed through a suitable extrusion process. The circumference of the ring is dimensioned to match the interior circumference of the pipes to be coupled. Along the outside circumference of the ring, a thermoplastic welding rod 120 is affixed by fusion relative to the outside edges of the band to form two bands 120a and 120b as shown in FIG. 1(a). The welding rod is a flexible thermoplastic rod, approximately 3/16″ (4.7 mm) in diameter, can be utilized although other diameters may be utilized. The rod comprises a central thermoplastic core with multiple super fine electrical resistance wires wound around the central core. The outer portion of the rod is coated with a thermoplastic coating. When an electrical current is applied to the wires the thermoplastic is heated and will fuse to plastics in contact with the welding rod. The welding rod becomes an integral part of the weld. The super fine wires remaining in the weld area and have no negative effect on the strength or longevity of the weld. As shown in FIG. 1 the bands are formed by a single welding rod wrapped around the outside of the plastic ring.

The positions of the bands formed by the welding rod are relative to the outside edge of the circular ring and can be determined based upon the application and the properties of the pipe to be coupled to provide a sufficient seal. However, the bands 120a and 120b are typically placed equidistance from the cross-sectional center of the coupler inset from the outer edges of the ring, as shown in sectional view in FIG. 1(c). The welding rod 120 is affixed around the ring 100 to provide at least one, preferable two, complete circles around the coupler for each band to ensure an adequate fusion zone to the associated pipe. The two sides of the bands 120a and 120b are connected by a portion of welding rod 123 connecting the two bands. The bands 102a, 120b and the connection portion 123 may be formed an individual segments or by a continuous welding rod. Alternatively the two band may be connected by a jumper wire (not shown) to prevent melting of the sheet across the coupling.

The welding rod is terminated with terminal pins 122 and 132 to which a power supply or current source is attached to heat the thermoplastic welding rod bands to the required temperature to enabling fusing with the pipe. The terminal pins 122 and 132 can be positioned facing towards the outer edge of the coupler to provide access between the coupler and the pipe wall when the coupler is positioned between the joins of the sections of pipe. Alternatively, the terminal pins may be fed through an opening in the coupler towards the interior, where the opening is fused during the welding process completing the seal. The terminal pins can then be removed.

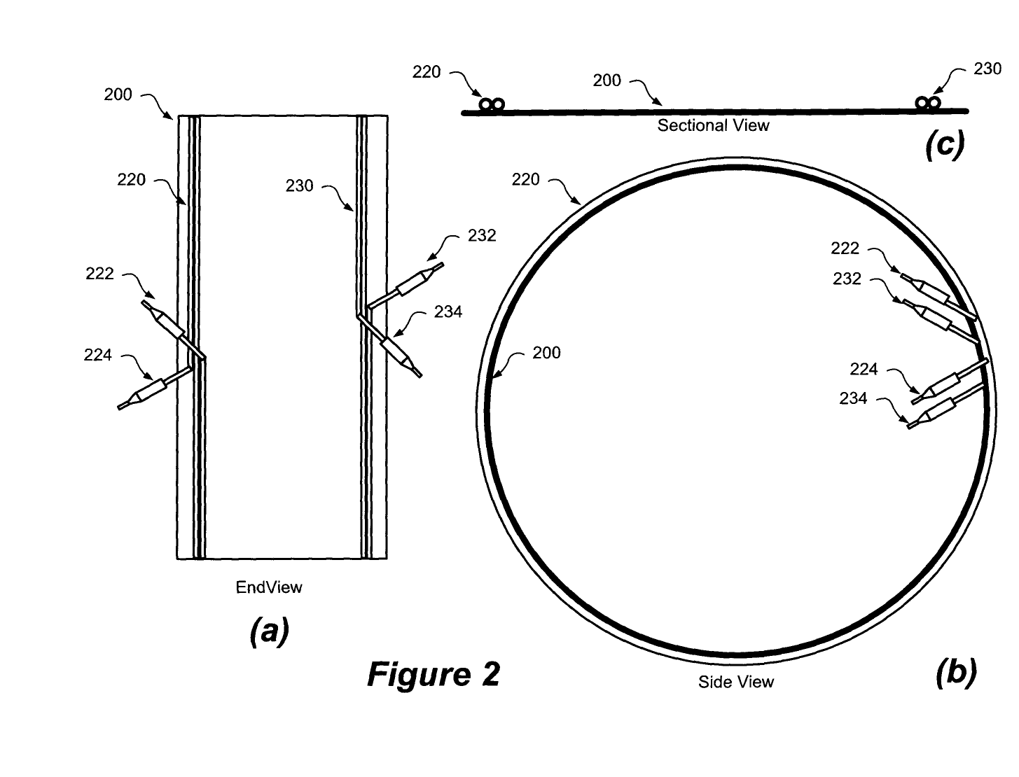

FIG. 2 (a) to (c) is an internal electrofusion ring coupler having separate welding rod bands. In this coupler two separate bands of welding rod 220 and 230 are utilized at each side of the coupler. An internal electrofusion ring coupler having separate welding rod bands may be required for large circumference pipes where the current required to fuse the welding rod is too high for using a single rod for each side of the band. In this embodiment, each band 220 and 230 has respective terminal pins 222, 224 and 232, 234. Again the pins may be positioned facing to the exterior of the coupler so that they are accessible between the coupler and the pipe wall when the coupler is positioned between the joins of the sections of pipe. Each band is welded separately to the internal circumference of the respective pipe end.

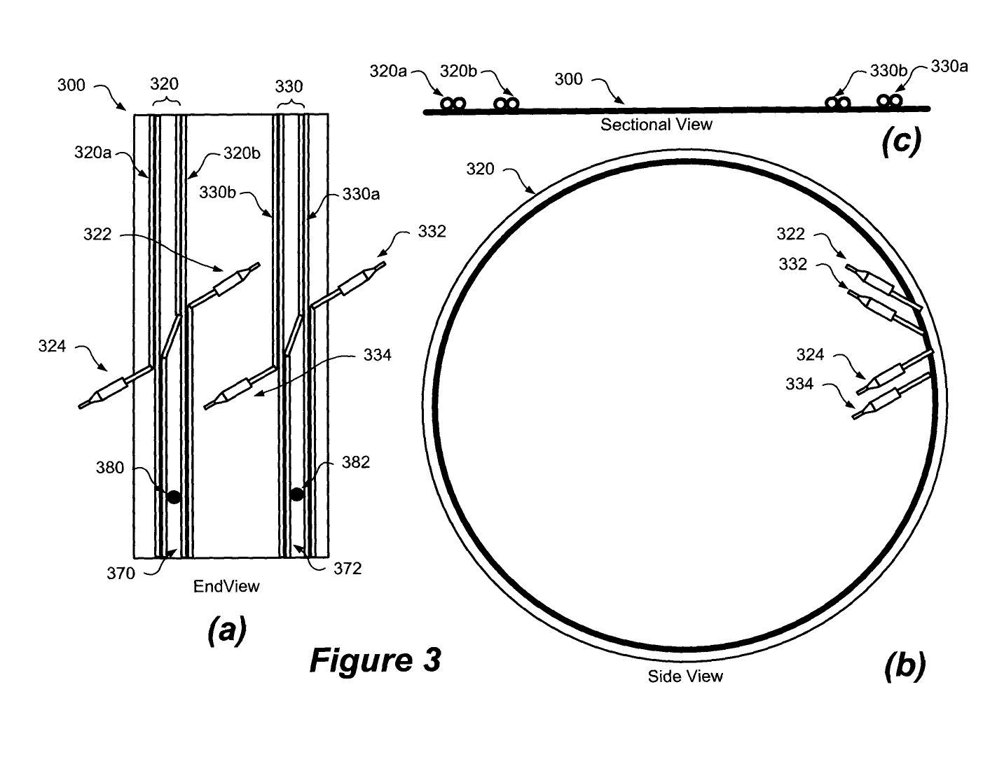

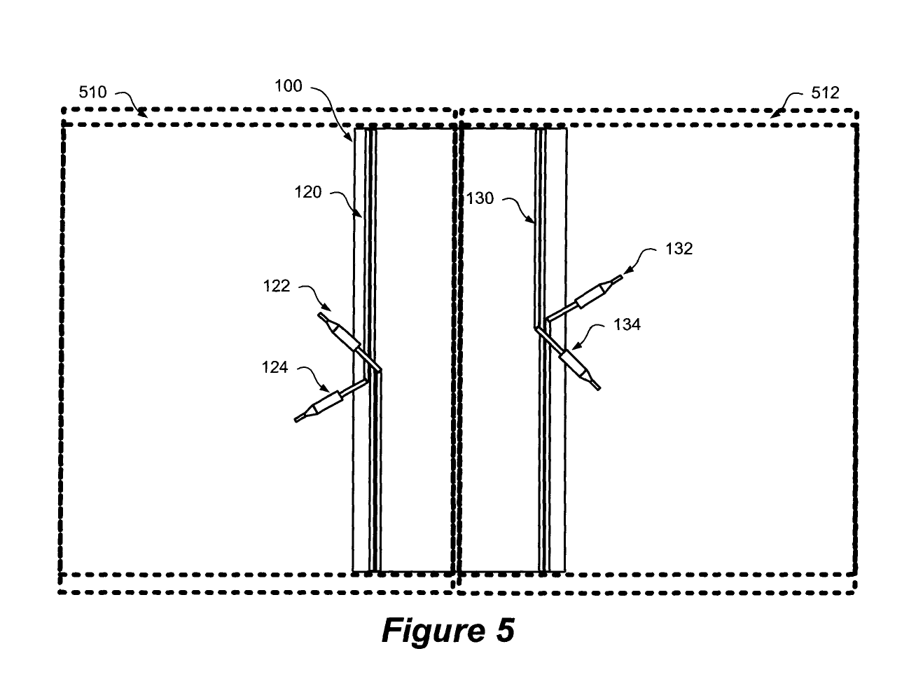

FIG. 3 (a) to (c) is an internal electrofusion ring coupler having separate welding rod bands with a pressure test cavity within each band 320 and 330 by forming dual rings for each band. In this coupler two separate bands 320a, 320b and 330a, 330b of welding rod are utilized to encircle the coupler at each side to form the cavity 370 and 372 between the bands. An access opening or valve, 380 and 382, can be provided within cavities 370 and 372 respectively to enable pressure testing to be performed on the welds. A dual band internal electrofusion ring coupler may be required for large circumference pipes where the current required to fuse the welding rod is too high for using a single rod. In this embodiment, each band, 320 and 330, has respective terminal pins 322,324 and 332, 334. The internal terminal pins 322 and 334 will be accessed by an opening through the coupling in the interior circumference while terminal pins 324 and 332 are accessible via the side of the coupling. The terminal pins 324 and 332 can be removed once the welding process is completed. Each band is welded independently to the respective pipe end. The pin terminals 324 and 332 may be positioned on the exterior circumference of the ring coupler so that the pin terminals may be accessed from the space between pipe ends (as for example the space between 510 and 512 in FIG. 5) to enable welding of the coupling from the exterior of the pipes. This is particularly applicable for small diameter pipes, whereas providing the terminals to the interior of the coupling may be convenient for large pipe diameters. As with the connector of a connecting rod 123 as shown in FIG. 1, a connector may be used to join bands 320a to 320b and 303a to 330b. Alternatively the two bands may be connected by a jumper wire (not shown) to prevent melting of the sheet across the coupling to form the cavity 370 and 372.

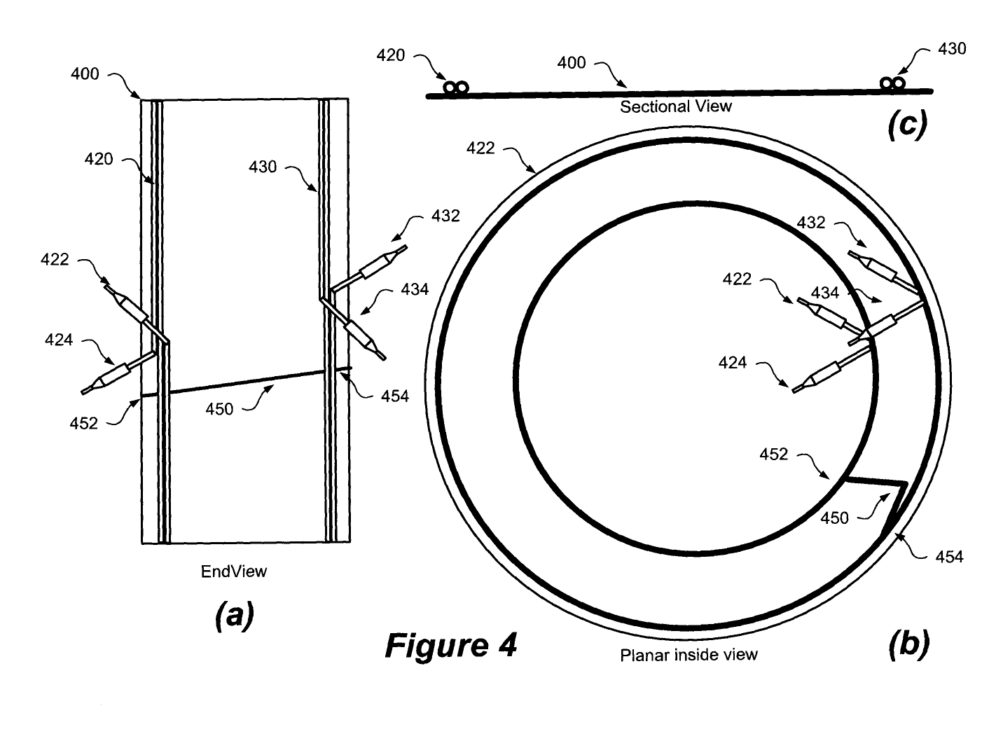

FIG. 4 (a) to (c) is a dual band internal electrofusion ring coupler where one side of the ring is expandable during the welding process to enable additional flexibility in positioning the coupling within the pipe ends. In this coupler two separate bands of welding rod 420 and 430 are utilized at each side of the coupler. In this embodiment, each band 420 and 430 has respective terminal pins 422, 424 and 432, 434. The expandability of the ring may be provided by a seam 450 where two portions of the ring overlap. One side 452 of the is fixed while the other side of the ring 454 overlaps providing excess material to allow the ring to be compressed during installation prior to welding of the ring coupler in place as shown in planar inside view 4(b). Alternatively, both sides of the coupler may overlap providing the ability to adjust both sides of the coupler to conform to the interior pipe shape. The welding rod bands can be expanded during the welding process when heated to ensure a tight fit. The seam provided at overlap 454 can then be sealed or heat welded to ensure closure.

FIG. 5 is a side view illustrating an internal electrofusion ring coupler positioned between two pipe ends. The ring coupler 500 is placed inside the ends of two pipes 510 and 512 respectively to cover the abutted ends of the pipe and seal the area in-between. Once the pipes are positioned with the ring coupler 500 is in place, an electrical current from a power supply or current source is applied to each band 520 and 530 through terminal pins 522, 524 and 532, 534 respectively. The electrical current results in the heating of the welding rod and fusion welding of the band 520 and 530 to the inner circumference of pipes 510 and 512. The terminal pins can then be removed from the ends of the thermoplastic rods. The ring coupler then provides a tight seal coupling the two ends of pipe ensuring a leak proof connection.

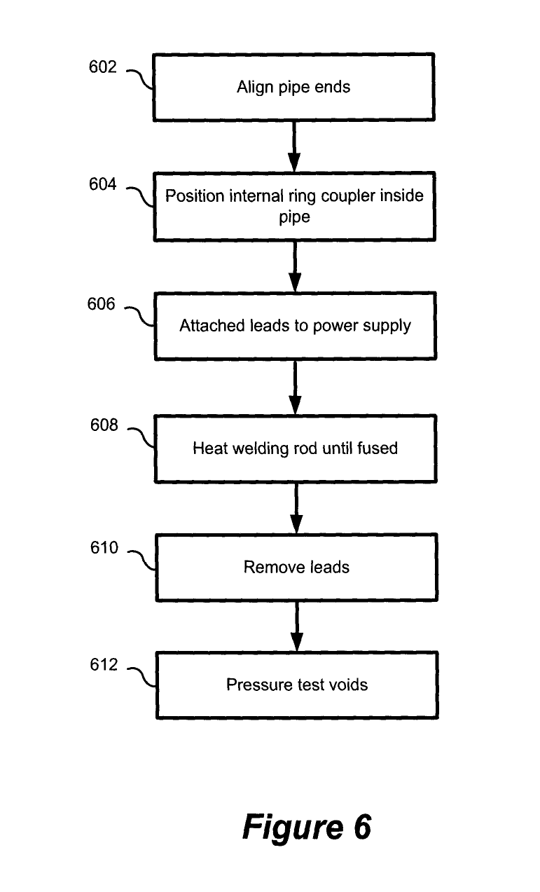

FIG. 6 shows a method of coupling plastic pipes using the internal ring coupler. The pipe ends to be joined are abutted and substantially aligned (602). The ring coupler is inserted within the pipe and aligned with the join formed by the ends of the pipe and positioned internally within the ends of two abutted pipe ends along an inner circumference of the abutted pipe ends (604). The power supply is attached to the leads of the welding rod (606) to apply an electrical current to the ends of the welding wire. Pressure is applied outwardly on the coupling to push the coupling against the inside of the pipes and ensure contact with the welding rod and the surface of the pipes and a current is applied until the welding rod fuses to the interior surface of the pipe (608). The leads of the welding rod can then be removed (610). If a pressure test void is present at the near ends of the coupling, a hole can be made and the voids pressure tested (612) to ensure a seal between the abutted pipes.

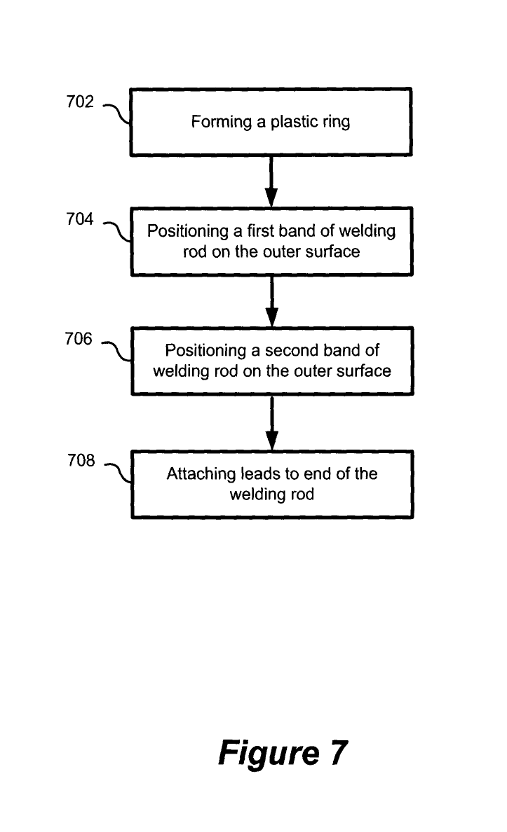

FIG. 7 shows a method of manufacturing an internal electrofusion ring coupler. The coupler is made by forming a plastic ring having a substantially flat outer surface (702) from a rectangular sheet of plastic material capable or fusing with a welding rod, or by an extrusion process to form ring segments. A first band of thermoplastic welding rod is positioned on the outer surface of the plastic ring relative to a first outer edge of the plastic ring (704). A second band of thermoplastic welding rod is positioned on the outer surface of the plastic ring relative to a second outer edge of the plastic ring, parallel to the first band (706). The bands are fused to the plastic ring by applying pressure and a heat source to the thermoplastic band enabling the first and second band to fuse to the surface of the ring. The first and second bands can be formed by a single continuous flexible thermoplastic welding rod or by individual continuous flexible thermoplastic welding rods. The band may be provided with separate leads to connect to a power source or be coupled by a wire jumper across the surface of the sheet.

Alternatively the circular band can be formed by overlapping plastic material such that one outer edge of the plastic ring is movable relative by the overlapping material. The overlapping material is movable relative to the circumference of the ring prior to the coupler being fused within the pipes to allow the ring to be compressed to fit within the pipes. The bands may also be formed with a space between each of the outer band and inner band of the first and second bands to allow the insertion of a valve for pressure testing. The bands may be formed as continuous rings around the coupling by wrapping the welding rod a number of times around the outer circumference of the coupler.

The ring coupler is manufactured by forming a plastic ring either by shaping a flat piece of plastic or by extruding the ring to which flexible welding rod is fused to the outer circumference of the ring coupler. The coupler may be manufactured by rotating the plastic ring and applying heat and pressure to a welding rod which is applied to the outside of the ring at predetermined location to form bands around the circumference of the ring. The bands may be formed by a single welding rod or each band may be formed by individual welding rods fused to the plastic material of the wring. The terminal leads are attached to the ends of the welding rod and may be accessible by the side of the coupler or through the interior of the ring coupler by access openings. In a dual band configuration, a cavity may be formed within each band to enable pressurization test to be performed to ensure the integrity of the weld.

The ring coupling may be utilized for joining pipes made of polyvinyl chloride (PVC) polyethylene, polypropylene, High-density polyethylene (HDPE), Polyvinylidene fluoride (PVDF) based pipes. Alternatively the coupler may be utilized for plastic lined pipes such as for example lined concrete, plastic lined steel pipe, plastic lined or consolidated glass reinforced pipe.

As will be appreciated by those of ordinary skill in the art, many refinements and modifications may be made to this novel technology without departing from the inventive concept(s) presented herein. The variants are presented solely to illustrate the broad applicability of the inventive concept(s) presented herein. The embodiments of the disclosure described above are intended to be exemplary only. As will be appreciated by those of ordinary skill in the art, to whom this specification is addressed, many obvious variations can be made to the embodiments present herein without departing from the spirit and scope of the disclosure. The scope of the exclusive right sought by the applicant is therefore intended to be limited solely by the appended claims.

1. An internal ring coupler for fusing and sealing a first pipe end to a second pipe end, the internal ring coupler comprising:
a plastic ring having a substantially flat outer surface;
a first thermoplastic welding rod band encircling the outer surface of the plastic ring, the first thermoplastic welding rod band positioned toward one outer edge of the plastic ring;
a second thermoplastic welding rod band encircling the outer surface of the plastic ring, the second thermoplastic welding rod band positioned toward an opposite outer edge of the plastic ring;
wherein the plastic ring is placed with the one outer edge inside the first pipe end and the opposite outer edge inside the second pipe end to cover the inner circumference of a pipe joint, and the first thermoplastic welding rod band fuses the plastic ring to the interior of the first pipe end and the second thermoplastic welding rod band fuses the plastic ring to the interior of the second pipe end, in each case by application of an electrical current to heat the welding rod.

2. The internal ring coupler of claim 1 wherein the first and second thermoplastic welding rod bands are formed by a single continuous flexible thermoplastic welding rod.

3. The internal ring coupler of claim 1 wherein the first and second thermoplastic welding rod bands are formed each by individual continuous flexible thermoplastic welding rods.

4. (canceled)

5. The internal ring coupler of claim 1 wherein the first and second thermoplastic welding rod bands are each further divided into an outer band and an inner band wherein once welded, the space between each of the outer band and inner band can be pressure tested to verify integrity of the welds.

6. (canceled)

7. The internal ring coupler of claim 5 wherein the plastic ring is formed by overlapping plastic material, wherein at least one outer edge of the plastic ring is movable relative to the overlapping material, the edge being movable relative to the circumference of the ring prior to the coupler being fused within the pipe ends.

8. The internal ring coupler of claim 5 further comprising an opening through the plastic ring in the space between each of the outer band and inner band of the first and second thermoplastic welding rod bands to allow for pressure testing of the space.

9. The internal ring coupler of claim 1 wherein each thermoplastic welding rod band comprises multiple super fine electrical resistance wires wound inside around a central core and an outer portion coated with a thermoplastic.

10. The internal ring coupler claim 1 wherein at least one end of a thermoplastic welding rod used to form one or both of the first and second thermoplastic welding rod bands is fed through an opening in the plastic ring to terminate within the interior of the plastic ring.

11. (canceled)

12. (canceled)

13. (canceled)

14. A method of coupling pipes, the method comprising:
providing an internal ring coupler comprising:
a plastic ring having a substantially flat outer surface;
a first thermoplastic welding rod band encircling the outer surface of the plastic ring, the first thermoplastic welding rod band positioned toward one outer edge of the plastic ring;
a second thermoplastic welding rod band encircling the outer surface of the plastic ring, the second thermoplastic welding rod band positioned toward an opposite outer edge of the plastic ring;
positioning the ring coupler internally with the one outer edge within an end of a first pipe and the opposite outer edge within an end of a second pipe to join the pipe ends; and
applying current to the first and second thermoplastic welding rod bands to weld the internal ring coupler to the interior surfaces of the pipe ends.

15. The method of claim 14 wherein the first and second thermoplastic welding rod bands are formed by a single continuous flexible thermoplastic welding rod.

16. The method of claim 14 wherein the first and second thermoplastic welding rod bands are each formed by individual continuous flexible thermoplastic welding rods.

17. (canceled)

18. The method of claim 14 wherein the first and second thermoplastic welding rod bands are each further divided into an outer band and an inner band wherein once welded, a space between each of the outer band and inner band can be is pressure tested to ensure a seal.

19. (canceled)

20. The method of claim 14 wherein the plastic ring is formed by overlapping plastic material, wherein at least one outer edge of the plastic ring is movable relative to the overlapping material, the edge being movable relative to the circumference of the ring prior to the coupler being fused within the pipes.

21. The method of claim 18 wherein an opening in the plastic ring is provided in the space between each of the outer band and inner band of the first and second thermoplastic welding rod bands and pressure testing of the space is performed via the opening.

22. The method of claim 14 wherein each thermoplastic welding rod band comprise multiple super fine electrical resistance wires wound inside around a central core and an outer portion coated with a thermoplastic.

23. The method of claim 14 wherein at least one end of a thermoplastic welding rod used to form one or both of the first and second thermoplastic welding rod bands is fed through an opening in the plastic ring to terminate within the interior of the plastic ring.

24. (canceled)

25. (canceled)

26. (canceled)

27. A method of manufacturing an internal electrofusion ring coupler, the method comprising:
forming a plastic ring having a substantially flat outer surface;
positioning a first thermoplastic welding rod band on the outer surface of the plastic ring relative to a first outer edge of the plastic ring;
positioning a second thermoplastic welding rod band on the outer surface of the plastic ring relative to a second outer edge of the plastic ring, parallel to the first band;
wherein the first and second thermoplastic welding rod bands are fused to the plastic ring by applying pressure and a current source to the thermoplastic welding rod bands enabling the first and second thermoplastic welding rod bands to fuse.

28. The method of claim 27 wherein the first and second thermoplastic welding rod bands are formed by a single continuous flexible thermoplastic welding rod.

29. The method of claim 27 wherein the first and second thermoplastic welding rod bands are each formed by individual continuous flexible thermoplastic welding rods.

30. (canceled)

31. The method of claim 27 wherein the first and second thermoplastic welding rod bands are each further divided into an outer band and an inner band wherein once welded, the space between each of the outer band and inner band can be pressure tested to ensure a seal.

32. (canceled)

33. The method of claim 27 wherein the plastic ring is formed by overlapping plastic material, wherein at least one outer edge of the plastic ring is movable relative by the overlapping material, the edge being movable relative to the circumference of the ring prior to the coupler being fused within the pipes.

34. The method of claim 31 wherein an opening is provided in the space between each of the outer band and inner band of the first and second bands to allow for pressure testing of the space.

35. The method of claim 27 wherein the thermoplastic welding rod comprise multiple super fine electrical resistance wires wound inside around a central core and an outer portion coated with a thermoplastic.

36. The method of claim 27 wherein at least one end of a thermoplastic welding rod used to form one or both of the first and second thermoplastic welding rod bands is fed through an opening in the plastic ring to terminate within the interior of the plastic ring.

37. (canceled)

38. (canceled)

39. (canceled)
